(19) United States
(12) Patent Application Publication
(10) Pub. No.: US 2026/0225216 A1
(43) Pub. Date: Aug. 6, 2026

(54) POWER TOOL

(71) Applicant: Hilti Aktiengesellschaft, Schaan (LI)

(72) Inventors: Jens KONDRATIUK, Buchs (CH); Steffen MUCHA, Schwabmuenchen (DE)

(21) Appl. No.: 19/154,048

(22) PCT Filed: Feb. 2, 2024
(86) PCT No.: PCT/EP2024/052650

§ 371 Date: Aug. 6, 2025

(30) Foreign Application Priority Data
Feb. 15, 2023 (EP) 23156749.6

(51) Int. Cl. B25D 17/04; B25D 17/26

(52) U.S. Cl. CPC B25D 17/04; B25D 17/26; B25D 2250/121; B25D 2250/331

(57) ABSTRACT

A power tool (10) including a drive (20), e.g. an electropneumatic drive (20), and a housing shell (12), wherein the drive (20) is mounted on the housing shell (12) via at least one plain bearing (32). It is characterized in that the plain bearing (32) has a friction reducer (36). As a result, it is possible to arrange additional holders, e.g. auxiliary handles (14), in a particularly convenient and appropriate manner on the power tool (10).

### DESCRIPTION

The invention relates to a power tool comprising a drive and a housing shell.

### BACKGROUND

There is often a need to attach an additional holder, e.g. an auxiliary handle, to a power tool of this kind. The holder can have a fastening clamp, by means of which it can be fastened on the power tool.

### SUMMARY OF THE INVENTION

In the case of handheld power tools, for example, it is to be recommended for ergonomic and functional reasons that the holder be fastened on the housing shell in the region of the plain bearing. In this case, however, the user should take care to ensure that the fastening clamp is tightened with a torque within a narrowly defined torque range. If the torque is too high, the plain bearing may be excessively preloaded and may, for example, jam as a result. If the torque is too low, the holder does not sit correctly on the housing shell.

During the normal use of the power tool with such a holder, malfunctions or failures are often the result. This may also damage the health of the user of the power tool if the user is thereby exposed to excessively strong vibration, for example.

It is an object of the invention to offer a power tool of the type stated at the outset which makes it possible to correctly mount an additional holder in a particularly simple way, it being particularly desirable that the power tool be capable of being produced at low cost.

The present invention provides a power tool comprising a drive, e.g. an electropneumatic drive, and a housing shell, wherein the drive is mounted on the housing shell via at least one plain bearing, wherein the plain bearing has a friction reducing means.

This makes it possible, in a surprisingly simple and particularly low-cost way, to considerably expand the permissible torque range for proper fastening of a fastening clamp of a holder or the like on the housing shell. For example, the friction reducing means allows a sliding movement of the body mounted in the plain bearing, e.g. a power tool spindle, even if a relatively high pressure is exerted on the plain bearing by the fastening clamp.

Tests have shown that the permissible torque range can be extended to such an extent in the case of the power tool that a user can tighten the fastening clamp without additional measuring equipment or the like while nevertheless keeping within the permissible torque range. Moreover, the user can generally detect a torque that is too low themselves since, in this case, the user will recognize that the fastening clamp is obviously sitting too loosely, being easily movable for example, on the housing shell.

This provides a particularly simple and convenient way of fitting the power tool with an additional holder, e.g. an auxiliary handle. Thus, there is no need for additional measuring equipment or special training measures for the user.

Furthermore, it is also possible to use a plain bearing to support the drive. The advantages associated with a plain bearing, e.g. good dust and dirt resistance and low production costs, are maintained. In particular, it is not necessary to have recourse to some other type of bearing, e.g. a ball bearing or a rolling bearing. Significant additional costs due to such a change can be avoided.

In principle, friction reducing means are available at very low cost. As a result of this too, the power tool remains capable of being produced at low cost, notwithstanding the improved convenience that it provides.

It has furthermore been found and is explained in greater detail below that at least one of the basic functions of the plain bearing, in particular, minimized transmission of vibrations from the drive to the housing shell and thus from there to any holder fitted, in particular an auxiliary handle, is further improved.

The plain bearing can have sliding surfaces. The friction reducing means can be applied to the sliding surfaces.

Accordingly, a particularly advantageous power tool can have a holder arranged on the housing shell via a fastening portion in such a way as to be detachable, in particular detachable without tools. The holder can be an additional side handle, for example. While the basic functioning of the plain bearing is maintained or improved, the holder provides an additional way of safely guiding the power tool. This may be necessary especially in the case of particularly powerful power tools, e.g. hammer drills or power chisels.

The fastening portion can have a fastening clamp, thus enabling it to be adapted in a flexible way to different dimensions of different embodiments of the power tool. The fastening clamp also enables the holder to be arranged nondestructively on the power tool or to be detached from it nondestructively.

It is advantageous if the friction reducing means remains in the plain bearing for a relatively long time and/or at high and/or prolonged continuous loads. Moreover, the friction reducing means should be as robust as possible with regard to dust or dirt, which must always be expected on construction sites, for example.

For this reason too, it is advantageous if the friction reducing means comprises a solid lubricant and, in particular, is a solid lubricant.

Alternatively or additionally, it is conceivable that the friction reducing means comprises a liquid lubricant. In this case, a liquid lubricant can be understood to mean a lubricant which is liquid at room temperature, e.g. 18-25° C., in particular 20° βC., or at a typical operating temperature, e.g. an operating temperature in the range from 30° C. to 130° C., e.g. 80° C.

In one category of embodiments, a lubricant reservoir can be provided. Thus, the plain bearing can be supplied with friction reducing means even over a prolonged period, e.g. over 5, 10 or 20 years.

The friction reducing means can comprise a multiplicity of microparticles, in particular lubricant-filled microparticles. The microparticles can serve as lubricant reservoirs.

In this case, it is particularly favorable that the microparticles can already be directly at their desired locations of action. The microparticles can thus release lubricants directly in situ. It is furthermore especially advantageous here that a particularly large number of microparticles can open and release their lubricant content under a high load of the kind that may occur, for example, in the case of fastening clamps that are tightened with high torques. It is thus possible to supply friction reducing means in the plain bearing in a manner that is particularly appropriate to requirements.

In the case of power tools which have an impact function, the drives, e.g. the electropneumatic drives, produce impacts along their longitudinal axes and, as a result, particularly severe vibrations. Effective vibration reduction is particularly important with these power tools. If, therefore, such power tools are designed with an impact function in the manner described here, risks to the health of users who, for example, fit and use an auxiliary handle on the power tool are reduced or even completely avoided.

The power tool can be arranged on a construction robot. It can be configured for performing construction work on a ceiling, a wall, and/or a floor. It may have a manipulator. An end effector can be formed on a free end of the manipulator. The power tool may be arranged and/or may be capable of being arranged on the end effector.

The manipulator can be designed as a robot arm. The manipulator can also have a lifting device. The lifting device can increase the size of the overall volume which can be reached by the manipulator. The manipulator can have at least three degrees of freedom. In particular, it can have at least six degrees of freedom.

The construction robot can also have a mobile platform. The mobile platform can comprise a wheeled undercarriage and/or a track-chain undercarriage. The mobile platform can have at least two degrees of freedom. The construction robot can have a total of at least eight, e.g. ten, degrees of freedom.

In the case of conventional power tools, vibrations of the power tool may be transmitted to the end effector of the construction robot. As a result, the end effector is likewise set in vibration, and therefore construction work by the construction robot can only be carried out with a low precision. The end effector, the manipulator and/or the mobile platform of the construction robot are also subject to particularly high mechanical loading by the vibrations. It is therefore particularly advantageous if the construction robot has a power tool of the type described hereinabove, making it possible to mount on the power tool a holder which enables optionally additional holding of the power tool, thus ensuring that no vibrations or only very slight vibrations are transmitted to the construction robot.

Alternatively or in addition, it is conceivable for the power tool to be designed as a handheld power tool. On such a power tool, it is possible, for example, to mount an auxiliary handle by which vibrations are transmitted to only a slight extent during the operation of the power tool. Risks to health due to excessive vibrational loads, e.g. to a user's hand, can be avoided or at least considerably reduced.

In general, the power tool can be designed to perform construction work on a building construction site and/or a civil engineering construction site. In particular, it can be designed for work on masonry, for example concrete. It is precisely for work on masonry that power tools with an impact function and particularly high individual impact energies are used. To enable the power tool to be guided safely despite these high individual impact energies, an auxiliary handle is to be recommended, thus enabling the abovementioned advantages to come into play in a particularly pronounced way in the case of such a power tool.

Further features and advantages of the invention are apparent from the following detailed description of exemplary embodiments of the invention, with reference to the figures of the drawing, which shows details essential to the invention, and from the claims. The features shown therein should not necessarily be considered to be true to scale and are illustrated in such a manner that the special features according to the invention can be clearly visualized. The various features can be implemented individually in their own right or collectively in any combinations in variants of the invention.

Exemplary embodiments of the invention are illustrated in the schematic drawing and will be explained in detail in the following description.

### BRIEF DESCRIPTION OF THE DRAWINGS

FIG. 1 shows a side view of a power tool having an auxiliary handle, and

FIG. 2 shows a view in longitudinal section of a plain bearing of the power tool.

### DETAILED DESCRIPTION

In the description of the figures that follows, comprehension of the invention is facilitated by use of the same reference signs in each case for identical or functionally corresponding elements.

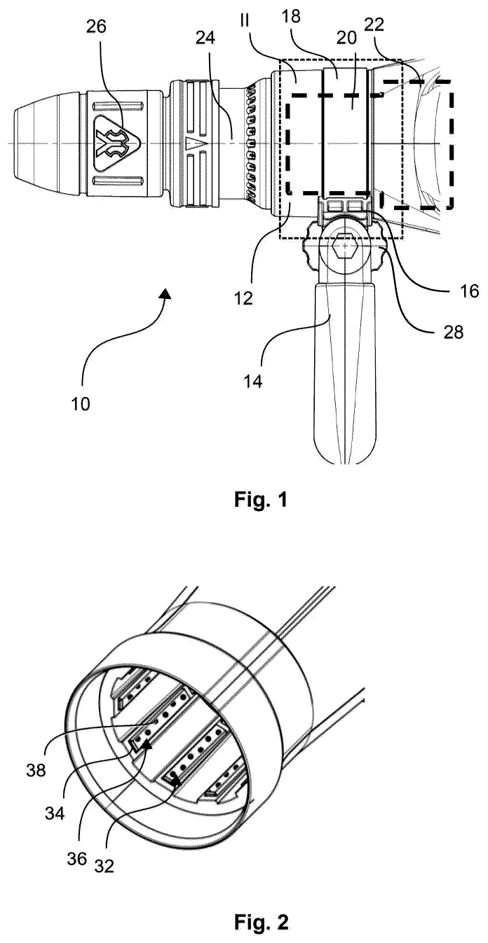

FIG. 1 shows a power tool 10. The power tool 10 is designed as a handheld power tool. In particular, the power tool 10 is designed as a hammer drill. It thus has an impact function.

FIG. 1 shows a side view of part of the power tool 10. It shows a housing shell 12, on which an auxiliary handle 14 is mounted via a fastening portion 16. The fastening portion 16 has a fastening clamp 18. The fastening clamp 18 surrounds a front region of the housing shell 12.

The power tool 10 has a drive 20. The drive 20 is situated within the housing shell 12, and therefore is only schematically represented in FIG. 1.

The drive 20 has an electropneumatic motor unit 22. The motor unit 22 drives a tool spindle 24. In particular, the tool spindle 24 can be driven in rotation, with a striking motion and/or with a rotary striking motion. The tool spindle 24 can comprise a steel. In particular, it can be formed from a steel. The tool spindle 24 ends in a tool fitting 26. A tool can be mounted in the tool fitting 26. For example, the tool can be a chiselling tool or a hammer drill tool.

The fastening clamp 18 has a clamping screw 28. By means of the clamping screw 28, it is possible to adjust the length of the fastening clamp 18 and thus its diameter. The pressure on the housing shell 12 can thus be increased or reduced depending on the torque with which the clamping screw 28 is tightened. In this way, it is also possible to adjust the firmness of the seating with which the fastening clamp 18 sits on the housing shell 12.

FIG. 2 now shows a detail of the power tool 10 in region Il according to FIG. 1. To simplify the illustration, the auxiliary handle 14 with its fastening clamp 18 and the housing shell 12 (see FIG. 1 in each case) are not illustrated here.

In particular, FIG. 2 shows a perspective, partially sectioned view of the illustrated region II. Here, the tool spindle 24 (likewise see FIG. 1) is also not illustrated. Thus, a view of an interior of the housing shell 12 in the illustrated region Il is obtained. In particular, a plain bearing 32 can be seen. The plain bearing 32 is thus situated between the housing shell 12 and the tool spindle 24. The plain bearing 32 thus supports the tool spindle 24 on the housing shell 12. The support can be direct or indirect. In the case of direct support, the tool spindle 24 can rest on the plain bearing 32. In an alternative embodiment with indirect support, the tool spindle 24 can be surrounded, at least in a radially encircling manner, by a drive housing. The drive housing can then rest on the plain bearing 32, and therefore the tool spindle 24 is supported indirectly on the plain bearing 32 via the drive housing.

The plain bearing 32 has a plurality of sliding surfaces 34. To simplify the illustration, only a single one of the sliding surfaces 34 is provided with a reference sign. The sliding surfaces 34 are designed in such a way as to be distributed at equal intervals from one another over the entire inner surface of the plain bearing 32, for example. The sliding surfaces 34 can be formed from a polymer. Friction reducing means 36 is located on the outer sides of the sliding surfaces 34 and/or in the interior of the sliding surfaces 34.

One example of a suitable friction reducing means 36 can comprise the following components:

As the basic material, a polyoxymethylene (e.g. material known as “Hostaform C9021”) can be provided, which contains polyurethane (PU)-based microcapsules, e.g. with 10 to 15% by weight, e.g. 12.5% by weight, of the friction reducing means 36.

The microcapsules contain a lubricant. The lubricant contained in the microcapsules can be a mixture of substances.

The capsule walls thereof can be polyurethane-based, in particular being formed by polyurethane. In general, the capsule walls can comprise a plastic, in particular a polymer.

The total quantity of lubricant contained in the microcapsules can be at least 50% by weight, e.g. between 50 and 95% by weight, e.g. in the region of 75 to 85% by weight, in particular 80% by weight, of the weight of the microcapsules.

The diameters of the microcapsules can be in the range of 20 to 250 μm. For example, their median diameter can be in the range from 1 to 100 μm, in particular from 20 to 50 μm.

The friction reducing means 36 thus has microcapsules 38. Once again, for reasons of simplification, only one of the microcapsules 38 is indicated by a reference sign in FIG. 2. The microcapsules 38 can be designed as microparticles or as nanoparticles.

The friction reducing means 36 can also comprise a solid lubricant, e.g. based on MOS₂ or PTFE.

### LIST OF REFERENCE SIGNS

10 Power tool
12 Housing shell
14 Auxiliary handle
16 Fastening portion
18 Fastening clamp
20 Drive
22 Motor unit
24 Tool spindle
26 Tool fitting
28 Clamping screw
32 Plain bearing
34 Sliding surface
36 Friction reducing means
38 Microcapsule
II Region

What is claimed is:

1-7. (canceled)

8. A power tool comprising:
a drive; and
a housing shell, the drive being mounted on the housing shell via at least one plain bearing, the plain bearing having a friction reducer.

9. The power tool as recited in claim 8 further comprising a holder arranged detachably on the housing shell via a fastening portion.

10. The power tool as recited in claim 9 wherein the fastening portion has a fastening clamp.

11. The power tool as recited in claim 8 wherein the friction reducer includes a solid or liquid lubricant.

12. The power tool as recited in claim 8 wherein the friction reducer includes a multiplicity of microparticles.

13. The power tool as recited in claim 8 wherein the power tool has an impact function.

14. The power tool as recited in claim 8 wherein the power tool is designed as a handheld power tool.

15. The power tool as recited in claim 8 wherein the drive is an electropneumatic drive.

16. The power tool as recited in claim 8 wherein the friction reducer includes lubricant-filled microparticles.

17. The power tool as recited in claim 9 wherein the holder is an auxiliary handle.

18. The power tool as recited in claim 9 wherein the holder is detachable from the housing shell without external tools.
